(19) United States
(12) Patent Application Publication
(10) Pub. No.: US 2012/0278443 A1
(43) Pub. Date: Nov. 1, 2012

(54) SERVER, DISPLAY DEVICE, AND CONTROL METHOD

(76) Inventors: Kenichi Taniuchi, Kanagawa (JP); Kohji Saiki, Kanagawa (JP)

(21) Appl. No.: 13/300,373

(22) Filed: Nov. 18, 2011

(30) Foreign Application Priority Data
Apr. 26, 2011 (JP) 2011-098668

(51) Int. Cl. G06F 15/16

(52) U.S. Cl. 709/219

(57) ABSTRACT

According to one embodiment, a server includes a communication module, an acquisition module, a generator, and a transmitter. In response to an access request to content stored in a storage server received via the communication module from an information terminal connected thereto, the acquisition module acquires the content and layout information related to display layout of the content from the storage server. The generator generates display data to display the content on a web browser in the display layout based on the layout information. The transmitter transmits the display data to the information terminal via the communication module.

### CROSS-REFERENCE TO RELATED APPLICATIONS

This application is based upon and claims the benefit of priority from Japanese Patent Application No. 2011-098668, filed Apr. 26, 2011, the entire contents of which are incorporated herein by reference.

### FIELD

Embodiments described herein relate generally to a server, a display device, and a control method.

### BACKGROUND

Generally, on information terminals such as mobile terminals, personal computers (PCs), and tablet terminals, an application program developed for a storage server is executed to enable browsing of various types of data including image, video, and text stored in the storage server. The user can access the data stored in the storage server from any of information terminals such as mobile terminals, PCs, and tablet terminals. Besides, the data stored in the storage server can be shared among the information terminals.

With conventional technologies, in the case where data stored in the storage server is browsed from various types of information terminals such as mobile terminals, PCs, and tablet terminals, there is need of an application program compatible with the operating system (OS) of each of the information terminals. Accordingly, such browsing is not easy to achieve in view of cost to develop an application program with respect to each OS.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a system configuration comprising a message board server according to an embodiment;

FIG. 2 is an exemplary block diagram of a hardware configuration of an information terminal, a message board server, and a storage server in the embodiment;

FIG. 3 is an exemplary functional block diagram of the information terminal, the message board server, and the storage server in the embodiment;

FIG. 4 is an exemplary ladder chart of the operation of a web browser, the message board server, and the storage server in the embodiment; and

FIG. 5 is an exemplary conceptual diagram of a browser display screen in the embodiment.

### DETAILED DESCRIPTION

In general, according to one embodiment, a server comprises a communication module, an acquisition module, a generator, and a transmitter. In response to an access request to content stored in a storage server received via the communication module from an information terminal connected thereto, an acquisition module is configured to acquire the content and layout information related to display layout of the content from the storage server. The generator is configured to generate display data to display the content on a web browser in the display layout based on the layout information. The transmitter is configured to transmit the display data to the information terminal via the communication module.

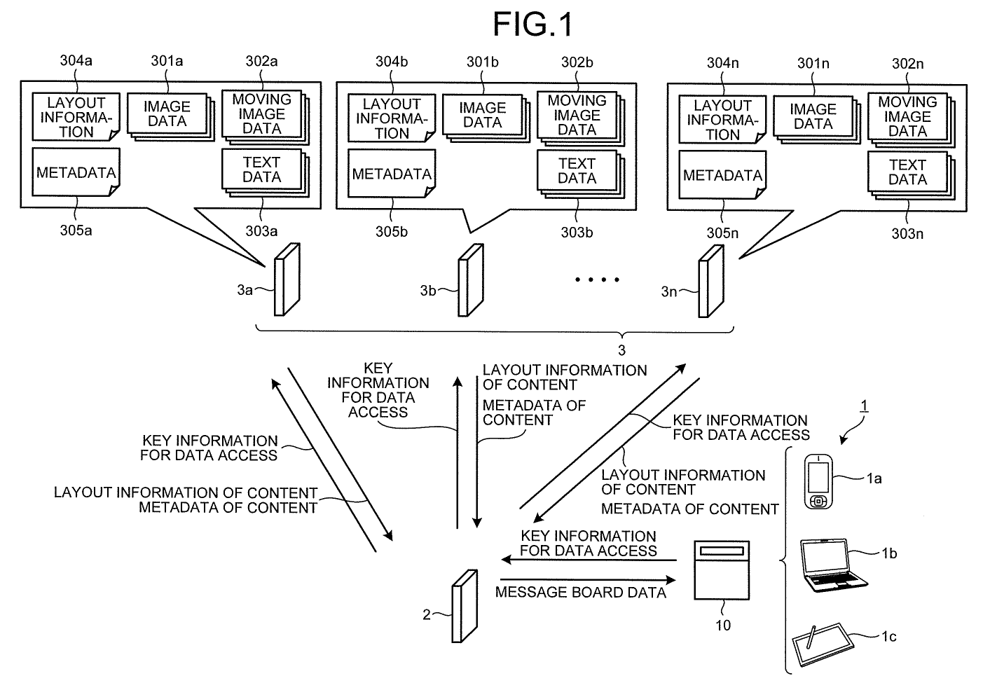

Exemplary embodiments will be described in detail below with reference to the accompanying drawings. FIG. 1 is a schematic diagram of a system configuration comprising a message board server 2 according to an embodiment.

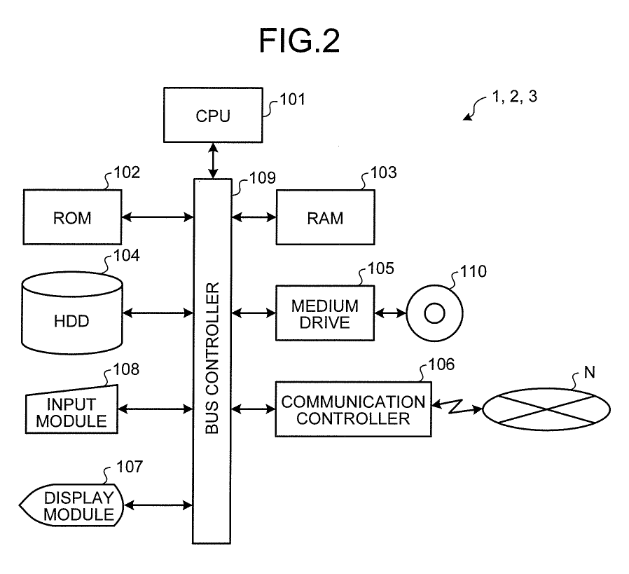

As illustrated in FIG. 1, a system including the message board server 2 comprises an information terminal 1 and a storage server 3. The information terminal 1 accesses the message board server 2 via a web browser 10. The storage server 3 stores content data (hereinafter, “content”) such as image, video, and text. In the system, the information terminal 1, the message board server 2, and the storage server 3 are connected to one another via a communication network N (see FIG. 2) such as the Internet or a local area network (LAN).

The information terminal 1 may be, for example, a mobile terminal 1a such as a mobile phone and a personal digital assistant (PDA), a personal computer (PC) 1b such as a notebook PC, a tablet terminal 1c such as an electronic book reader. As a central processing unit (CPU) executes a program, the information terminal 1 offers the function of the web browser 10 for browsing information provided by a web server.

The message board server 2 is a web server and provides the web browser 10 with display of objects such as hypertext markup language (HTML) and images in response to an access from the web browser 10 according to a communication protocol such as hypertext transfer protocol (HTTP). More specifically, when accessed from the web browser 10, the message board server 2 displays a message board on the web browser 10 to browse content such as image, video, and text stored in the storage server 3. For example, the message board server 2 returns message board data in HTML format or extensible markup language (XML) format. The message board data contains, for example, an executable script such as JavaScript (registered trademark) that the web browser 10 directly executes and binary data executed by a plug-in program such as a flash (registered trademark) plug-in, which is installed to extend the function of the web browser 10.

The storage server 3 stores content such as image, video, and text and various types of data in a mass storage medium such as a hard disk drive (HDD), and provides the data in response to an access from the information terminal 1, the message board server 2, and the like. A uniform resource indicator (URI) is specified to access the data stored in the storage server 3. The URI required to access the data includes a domain name, a data ID, a shared key (key information), and the host name of the storage server 3. That is, when the user accesses data in the storage server 3 from the information terminal 1 or the like, the storage server 3 is notified of the URI of where the data is stored and a shared key required to access the data. The storage server 3 authenticates the shared key from the URI. If access is permitted, the storage server 3 reads the data specified by the URI and returns the data to the sender of the URI. The shared key is issued if the user permits to share the data in the storage server 3 and is sent to a person the user wants to share the data with by email or the like.

In this manner, an access is made to data stored by a shared key in the storage server 3, which increases the confidentiality. Besides, a shared key is issued if the user permits to share data in the storage server 3 and is sent to a person the user wants to share the data with by, for example, email. Thus, the data can be shared.

In addition to data related to content such as image, video, and text, the storage server 3 stores layout data on the display layout of each content and metadata indicating what the content is about.

The layout information may contain at least one of display conditions including display coordinates to display content on a message board or the like, display size, display angle indicating the orientation of display, display color information, and the size of the message board on which the content is displayed. The layout information for each content may be described in a file having a name unique to the content, or layout information for contents may be described in a single file each with identification information that identifies the content. If, for example, content is an image, the display size may be the number of vertical and horizontal pixels or magnification of the original size. The display color information may be any kind of color information related to the content such as, for example, the background color of the content displayed on a message board or the like and the color of shade on the content.

The metadata is generated in the storage server 3 when content is stored in the storage server 3 or according to user operation via the web browser 10. The metadata may be information on the time the content is stored/updated in the storage server 3, the file name of the content, the type of the content such as music, a moving image, or a still image, the data amount of the content, URI indicating where the content is stored, tag information attached by the user, and the like. The tag information may be copyright information such as a person having copyright of the content and whether reproduction is permitted. Further, if the content is music, the tag information may indicate the title, the songwriter, and the lyrics. If the content is a moving image or a still image, the tag information may indicate information on the shooting date and time and the like equivalent to the exchangeable image file format (EXIF). As with the layout information, the metadata of each content may be described in a file for each content, or metadata of contents may be described in a single file.

The storage server 3 may comprise a plurality of storage servers 3a, 3b, . . . , and 3n. More specifically, the storage server 3a stores data related to content such as image data 301a, moving image data 302a, and text data 303a, layout information 304a related to display layout of the content, and metadata 305a indicating the substance or subject of the content. Similarly, the storage server 3b stores image data 301b, moving image data 302b, text data 303b, layout information 304b, and metadata 305b. The storage server 3n stores image data 301n, moving image data 302n, text data 303n, layout information 304n, and metadata 305n. The information terminal 1 and the message board server 2 specifies a URL indicating the address of the storage server 3a, 3b, . . . , or 3n in the communication network N and sends key information thereto to gain access to the data stored in the storage server 3a, 3b, . . . , or 3n.

The embodiment will be schematically described below. In the embodiment, the web browser 10 activated on the information terminal 1 notifies the storage servers 3a, 3b, . . . , and 3n of key information for data access and thereby accesses the message board server 2. Having accessed from the web browser 10, the message board server 2 notifies the storage servers 3a, 3b, and 3n of the key information for data access. The message board server 2 obtains content stored by the user as well as metadata and layout information of the content, and generates message board data to display the content to return it to the web browser 10. Upon receipt of the message board data, the web browser 10 displays a message board displaying contents stored in the storage servers 3a, 3b, . . . , and 3n by the user. Accordingly, in the embodiment, to browse content stored in the storage servers 3a, 3b, . . . , and 3n by the user, there is no need to have an application program for browsing compatible with each OS. Thus, data can be easily browsed.

FIG. 2 is a block diagram of an example of a hardware configuration of the information terminal 1, the message board server 2, and the storage server 3. The information terminal 1, the message board server 2, and the storage server 3 each comprises a central processing unit (CPU) 101, a read only memory (ROM) 102, a random-access memory (RAM) 103, a hard disk drive (HDD) 104, a medium drive 105, a communication controller 106, a display module 107, an input module 108, and a bus controller 109. The CPU 101 performs information processing. The ROM 102 stores basic input/output system (BIOS), and the like. The RAM 103 rewritably stores various data. The HDD 104 functions as various types of databases and stores various types of programs. The medium drive 105 may be, for example, a compact disk read-only memory (CD-ROM) drive to distribute information to the outside, to obtain information from the outside, and to store information using a storage medium 110. The communication controller 106 communicates information with an external device via the communication network N. The display module 107 may be, for example, a liquid crystal display (LCD) to display information such as processing progress and result. The input module 108 comprises a keyboard, a mouse, a touch panel, and the like to input information and commands to the CPU 101. The bus controller 109 controls data exchange among these modules.

When the information terminal 1, the message board server 2, and the storage server 3 configured as above are turned on, the CPU 101 invokes a program called loader in the ROM 102. The CPU 101 then loads a program called operating system (OS) that manages computer software and hardware into the RAM 103 and boots up the OS. The OS reads and stores information, and activates a program in response to user operation. As a typical example of the OS, Windows (registered trademark) is known. An operation program running on the OS is called application program. The application program need not necessarily run on a predetermined OS. The application program may cause the OS to take over part of various types of processing, which will be described later, or may be included in a series of program files that constitute predetermined application software, OS, or the like.

The information terminal 1 stores, as an application program, a program in the HDD 104 as the web browser 10 to browse information provided by a web server such as the message board server 2. The message board server 2 stores, as an application program, a program in the HDD 104 as a web server to return message board generated in response to an access from the web browser 10. The storage server 3 stores, as an application program, a program in the HDD 104 to return various data stored therein in response to an access from the information terminal 1 and the message board server 2. In this sense, the HDD 104 functions as a storage medium that stores programs.

Generally, an application program to be installed on the HDD 104 is stored in the storage medium 110 including various types of optical discs such as CD-ROM and DVD, various types of magneto-optical discs, various types of magnetic disks such as a flexible disk (FD), and various types of media such as a semiconductor memory. The operation program stored in the storage medium 110 is then installed on the HDD 104. Accordingly, portable optical storage media such as CD-ROM and portable magnetic storage media such as FD may be the storage medium 110 that stores an application program. The application program may be obtained from the outside via the communication controller 106 and installed on the HDD 104.

When a program starts up on the OS in the information terminal 1, the message board server 2, and the storage server 3, the CPU 101 performs various types of operations and collectively controls the respective modules. A description will be give of functional configurations implemented by the CPU 101 on the information terminal 1, the message board server 2, and the storage server 3.

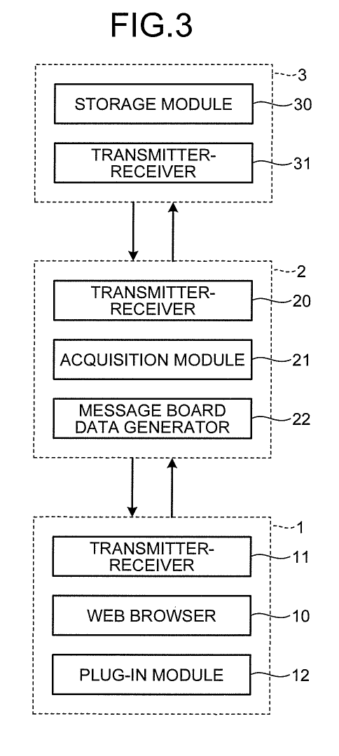

FIG. 3 is a functional block diagram of the information terminal 1, the message board server 2, and the storage server 3. As illustrated in FIG. 3, by executing the program mentioned above, the information terminal 1 has the functions of the web browser 10, a transmitter-receiver 11, and a plug-in module 12. By executing the program mentioned above, the message board server 2 has the functions of a transmitter-receiver 20, an acquisition module 21, and a message board data generator 22. By executing the program mentioned above, the storage server 3 has the functions of a storage module 30 and a transmitter-receiver 31.

The transmitter-receivers 11, 20, and 31 transmit and receive data via the communication controller. For example, the transmitter-receivers 11, 20, and 31 transmit and receive data via communication according to a communication protocol such as HTTP. More specifically, the transmitter-receivers 11, 20, and 31 transmit and receive key information for data access, content such as image data, video data, and text data, message board data, metadata, and layout information of the content. The plug-in module 12 is implemented by a plug-in program such as a flash (registered trademark) plug-in installed in advance, and provides the web browser 10 with various types of extended functions.

The acquisition module 21 receives an access request to content stored in the storage server 3 from the information terminal 1 via the transmitter-receiver 20. Upon receipt of the request, the acquisition module 21 acquires the content and metadata and layout information of the content from the storage server 3. More specifically, the acquisition module 21 receives key information for data access to the storage server 3 from the information terminal 1 as an access request to the storage server 3. The acquisition module 21 notifies the storage server 3 of the key information. Then, the acquisition module 21 acquires content stored in a location identified by a uniform resource identifier (URI) obtained if the key information is authenticated, and metadata and layout information of the content from the storage server 3.

The message board data generator 22 generates message board data (display data) to display the content acquired by the acquisition module 21 on the web browser 10 in a display layout based on the layout information acquired by the acquisition module 21. More specifically, the message board data generator 22 generates HTML or XML to add display coordinates, a display size, a display angle indicating the orientation of display, display color information, a display tag, and a file name contained in the layout information to the content. If the content is to be displayed by a plug-in program such as a flash (registered trademark) plug-in, the message board data generator 22 generates binary data to display the content in the display layout.

The message board data generator 22 generates message board data to display the content on the web browser 10 according to the substance or subject of the content based on the metadata acquired by the acquisition module 21. More specifically, the message board data generator 22 generates HTML or XML to add a display tag to display the metadata near the content. The HTML code may contain an executable script to display the metadata of the content in a pop-up when a mouse cursor or the like is placed on the content.

According to the metadata, if the data amount of content exceeds a predetermined value, the message board data generator 22 generates message board data to display the content on the web browser 10 based on link information (URI) indicating a location where the content is stored. More specifically, if the data amount of content exceeds a predetermined value, the message board data generator 22 generates message board data in which a URI indicating the location of the content is described in an HTML or an XML without generating message board data to which is attached the content with an HTML or an XML. In this manner, if the data amount of content exceeds a predetermined value, the message board data generator 22 generates message board data describing a URI indicating a location where the content is stored. With this, when a plurality of web browsers (10) access the message board server 2, it is possible to reduce the communication convergence and the load on the message board server 2.

The message board data generator 22 generates message board data to display a label image corresponding to the type of content indicated by metadata in a position corresponding to the content. For example, if the metadata indicates that the content is music, the message board data generator 22 generates an HTML or an XML to which is attached a display tag to display a label image such as an icon or a musical symbol like a clef near or on the content. In this manner, a label image is displayed with music content on the web browser 10. Thus, the user can easily find the music content from among various contents. Similarly, a label indicating the type of content is displayed with still image content and moving image content at a position corresponding to the content.

The message board data generator 22 generates message board data to display the content on the web browser 10 based on link information (URI) indicating a location where the content is stored according to information related to the copyright of the content indicated by the metadata. More specifically, if the information related to the copyright of the content indicates the copyright owner and that reproduction is not permitted, the message board data generator 22 generates message board data in which a URI indicating the location of the content is described in an HTML or an XML without generating message board data to which is attached the content with an HTML or an XML. In this manner, the message board data generator 22 may generate message board data according to information related to the copyright of content indicated by metadata. If the use of the content is not permitted by the copyright owner, the content may be directly accessed via a URI.

The storage module 30 manages image data, moving image data, text data, layout information, and metadata that are stored in the HDD or the like. More specifically, in response to an access through the transmitter-receiver 31 by a URI and key information, the storage module 30 reads data specified by the URI and the key information and returns the data to the accessor or the access source.

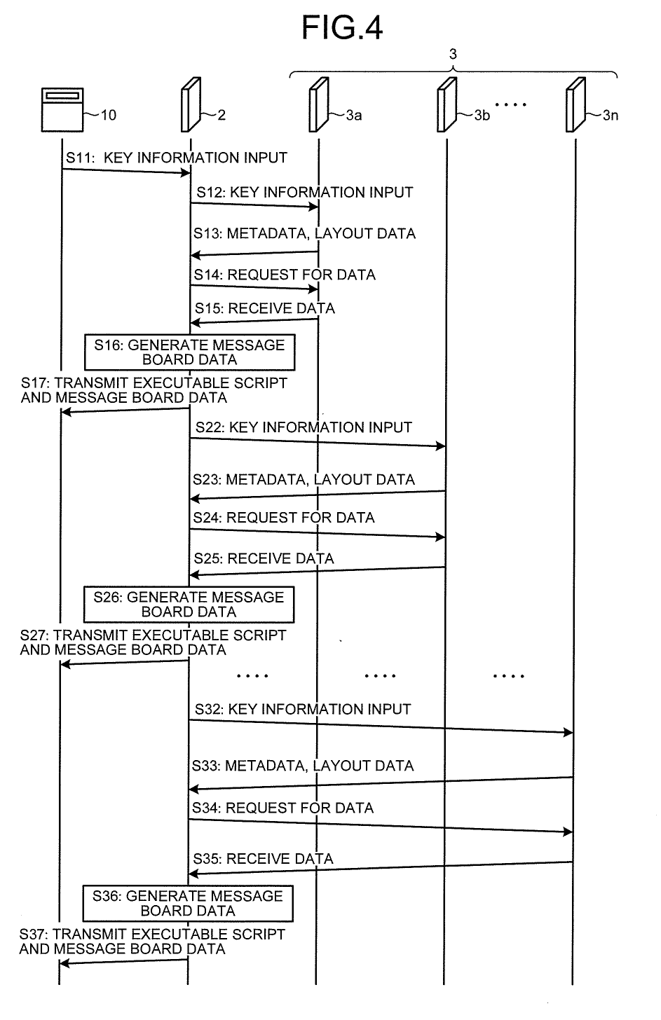

A description will be given of the operation of the web browser 10 activated on the information terminal 1, the message board server 2, and the storage server 3. FIG. 4 is a ladder chart illustrating an example of the operation of the web browser 10, the message board server 2, and the storage server 3.

As illustrated in FIG. 4, when the web browser 10 is activated and a message board provided by the message board server 2 starts being accessed, key information for data access is received from the web browser 10 and is reported to the message board server 2 (S11). The report of the key information may be performed by notifying the message board server 2 of a file containing the key information in response to the press of a button to start accessing the message board or the like. The key information may also be reported as a character string following the URL of the message board server 2 when the web browser 10 accesses the message board server 2.

Next, the message board server 2 notifies the storage servers 3a, 3b, . . . , and 3n of the key information received and reported from the web browser 10 (S12, S22, S32). The message board server 2 then acquires metadata and layout data (layout information) from the storage servers 3a, 3b, . . . , and 3n (S13, S23, S33). Subsequently, the acquisition module 21 of the message board server 2 requests the storage servers 3a, 3b, . . . , and 3n for data of content based on the URI of the content contained in the metadata (S14, S24, S34). Thus, the message board server 2 receives the data of the content from the storage servers 3a, 3b, . . . , and 3n (S15, S25, S35).

Thereafter, the message board data generator 22 of the message board server 2 generates an executable script and message board data to display the content on the web browser 10 in a display layout based on the layout data according to the metadata (S16, S26, S36). After that, the transmitter-receiver 20 of the message board server 2 transmits the executable script and the message board data to the web browser 10 (S17, S27, S37).

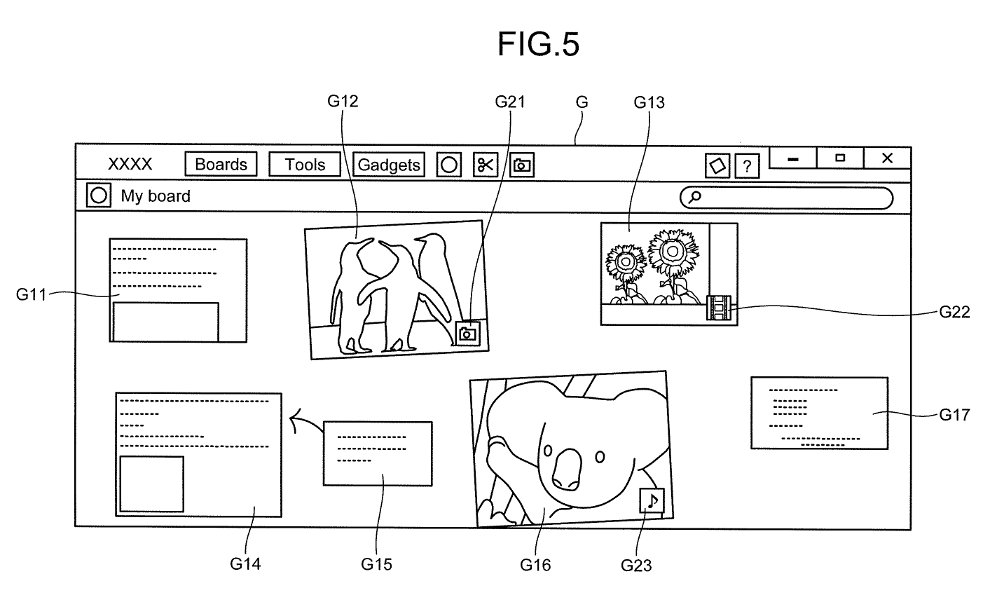

FIG. 5 illustrates an example of a browser display screen G. As illustrated in FIG. 5, the browser display screen G of the web browser 10 displays images G11 to G17 corresponding to contents stored in the storage servers 3a, 3b, . . . , and 3n. More specifically, the images G11 to G17 are each displayed at a position defined by display coordinates indicated by layout information. Besides, as the images G12 and G16, if the layout information indicates to display content at an angle, the content is displayed at angle in a direction indicated by the layout information. Content such as the still image G12 is displayed with a label image G12 indicating still image content. Similarly, content such as the moving image G13 is displayed with a label image G22 indicating moving image content, while the image G16 including music is displayed with a label image G23 indicating music content. With this, the user can easily recognize the images G12, G13, and G16 as still image content, moving image content, and music content, respectively.

With the web browser 10 that displays data using HTML or XML, the display layout on the browser display screen G can be similarly applied to various type of information terminals including the mobile terminal 1a, the PC 1b, and the tablet terminal 1c. The display layout as described above may be updated by, for example, dragging the images G11 to G17 by a mouse cursor (not illustrated) on the browser display screen G. In this case, the drag operation is received by the executable script and is reported to the message board server 2. The message board server 2 updates the layout information stored in the storage server 3.

A computer program can be executed on a computer to realize the same function as the message board server 2. The computer program may be provided as being stored in advance in ROM or the like. The computer program may also be provided as being stored in a computer-readable storage medium, such as a compact disc-read only memory (CD-ROM), a flexible disk (FD), a compact disc recordable (CD-R), and a digital versatile disc (DVD), as a file in an installable or executable format.

The computer program may also be stored in a computer connected via a network such as the Internet so that it can be downloaded therefrom via the network. Further, the computer program may be provided or distributed via a network such as the Internet.

The computer program comprises modules that implement the above functional elements. As real hardware, the CPU (processor) loads the computer program from the ROM into the main memory and executes it. With this, the functional elements are implemented on the main memory.

In the above embodiment, an example is described in which communication is performed among the information terminal 1, the message board server 2, and the storage server 3 using HTTP. The communication may be encrypted over hypertext transfer protocol over secure socket layer (HTTPS) to prevent information leakage to the outside. Besides, when accessed from the web browser 10 of the information terminal 1, the message board server 2 may check the use language, version, and the like of the web browser 10 using HTTP to generate message board data corresponding to the use language and the version. More specifically, if the version of the web browser 10 is not compatible with message board data to be generated, the message board server 2 may generate data indicating error and notify the web browser 10 of the data. Further, images of keys or the like displayed on the message board of the web browser 10 may correspond to the use language. Having detected unauthenticated (error) access from the web browser 10, the message board server 2 may store, in a storage therein, the IP address of an accessor or an access source, the user agent of the web browser 10, the access time, a page accessed, error information upon occurrence of an error, and the like as a log.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server comprising:
a communication module;
an acquisition module configured to acquire, in response to an access request to content stored in a storage server received via the communication module from an information terminal connected, the content and layout information related to display layout of the content from the storage server;
a generator configured to generate display data to display the content on a web browser in the display layout based on the layout information; and
a transmitter configured to transmit the display data to the information terminal via the communication module.

2. The server of claim 1, wherein
the layout information contains at least one of display conditions including display coordinates to display the content, display size, orientation of display, and display color, and
the generator is configured to generate the display data to display the content on the web browser based on the display conditions contained in the layout information.

3. The server of claim 1, wherein, if data amount of the content exceeds a predetermined value, the generator generates the display data to display the content on the web browser based on link information indicating a location where the content is stored in the storage server.

4. The server of claim 1, wherein
the acquisition module is configured to acquire metadata indicating substance of the content from the storage server with the content, and
the generator is configured to generate the display data to display the content on the web browser according to the substance of the content based on the metadata.

5. The server of claim 4, wherein the generator is configured to generate the display data to display a label image indicating a type of the content indicated by the metadata at a position corresponding to the content.

6. The server of claim 4, wherein the generator is configured to generate the display data to display the content on the web browser based on link information indicating a location where the content is stored in the storage server according to information related to copyright of the content indicated by the metadata.

7. The server of claim 1, wherein the acquisition module is configured to acquire key information required to access data stored in the storage server from the information terminal to acquire the content from the storage server.

8. A display device comprising:
a communication module;
a request module configured to send an access request via the communication module to a server connected to access content stored in a storage server;
a receiver configured to receive display data generated by the server, which acquires the content and layout information related to display layout of the content from the storage server in response to the access request, to display the content on a web browser in the display layout based on the layout information; and
a display module configured to display the content on the web browser based on the display data.

9. A control method applied to a server comprising a communication module, the control method comprising:
acquiring, by an acquisition module, in response to an access request to content stored in a storage server received via the communication module from an information terminal connected, the content and layout information related to display layout of the content from the storage server;
generating, by a generator, display data to display the content on a web browser in the display layout based on the layout information; and
transmitting, by a transmitter, the display data to the information terminal via the communication module.
